(19) United States
(12) Patent Application Publication
(10) Pub. No.: US 2019/0009395 A1
(43) Pub. Date: Jan. 10, 2019

(54) HAND TOOL AND GRIPPING SLEEVE THEREOF

(71) Applicant: Ming-Lung HSU, Taichung City (TW)

(72) Inventor: Ming-Lung HSU, Taichung City (TW)

(21) Appl. No.: 15/997,121

(22) Filed: Jun. 4, 2018

(30) Foreign Application Priority Data
Jul. 5, 2017 (TW) 106122489

(51) Int. Cl. B25B 23/00; B25G 1/00

(52) U.S. Cl. CPC B25B 23/0035; B25B 13/06; B25G 1/005

(57) ABSTRACT

A gripping sleeve is provided, including: a first sleeve, being substantially tubular and having at least one through hole; at least one restricting member, received in the through hole; a second sleeve, sleeved on the first sleeve and being movable relative to the first sleeve, the restricting member being abutted by the second sleeve and being controllably engaged within an annular groove of a body portion of a main body; an elastic member, disposed around the first sleeve and abutting against the first and second sleeves; a restricting mechanism, arranged on at least one of the first and second sleeves and located between the first sleeve and an outer circumferential face of the second sleeve. A hand tool is further provided, including the main body and the gripping sleeve.

### BACKGROUND OF THE INVENTION

### Field of the Invention

The present invention relates to a hand tool and a gripping sleeve thereof

### Description of the Prior Art

A hand tool is often used to screw or disassemble objects from devices. When assembling or disassembling an object, a user needs to rotate the hand tool toward a same direction so as to tighten or loosen the object. When in operation, the user can rotate a gripping portion of the hand tool with one hand, so it is less stable and may cause a connecting rod of the hand tool to fall off from the object.

In a hand tool commonly seen, a gripping sleeve body is sleeved on a middle section of a rod body of the hand tool for the hand tool to rotate relative to the gripping sleeve body, and this type of hand tools are T-type wrenches, Y-type wrenches and ratchet wrenches. In a prior art disclosed in TWI 581919, a controlling member is sleeved on an exterior circumference of a front section of an engaging member; a sleeve is sleeved on the controlling member and screwed to the engaging member, and the sleeve extends radially to form a flange to prevent the controlling member from falling off from the engaging member. However, the prior art has a more complicated structure.

The present invention has arisen to mitigate and/or obviate the afore-described disadvantages.

### SUMMARY OF THE INVENTION

The major object of the present invention is to provide a hand tool and a gripping sleeve thereof which has a simple structure.

To achieve the above and other objects, a gripping sleeve is provided, for being restrictably and slidably sleeved on a body portion of a main body and rotatable relative to the body portion, the body portion has at least one annular groove, and the gripping sleeve includes: a first sleeve, being substantially tubular and having at least one through hole; at least one restricting member, received in the through hole; a second sleeve, sleeved on the first sleeve and being movable relative to the first sleeve, the restricting member being abutted by the second sleeve, a part of the restricting member being controllably engaged within the annular groove; an elastic member, disposed around the first sleeve and abutting against and between the first sleeve and the second sleeve; a restricting mechanism, arranged on at least one of the first sleeve and the second sleeve and located between the first sleeve and an outer circumferential face of the second sleeve; the first sleeve further includes an outer sleeve and an inner sleeve, a receiving groove is formed between the inner sleeve and the outer sleeve and extends axially, and the second sleeve is sleeve on the inner sleeve and movably arranged within the receiving groove.

To achieve the above and other objects, a hand tool is provided, including the above-mentioned gripping sleeve and main body, wherein the main body further includes a driving portion which is connected to one of two ends of the body portion and a joint which is connected to the other of the two ends of the body portion.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a first preferred embodiment of the present invention;

FIG. 2 is a perspective breakdown of the first preferred embodiment of the present invention;

FIG. 3 is a cross-sectional view of the first preferred embodiment of the present invention;

FIG. 4 is a drawing showing the first preferred embodiment of the present invention in movement; and

FIG. 5 is a cross-sectional view of a second preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

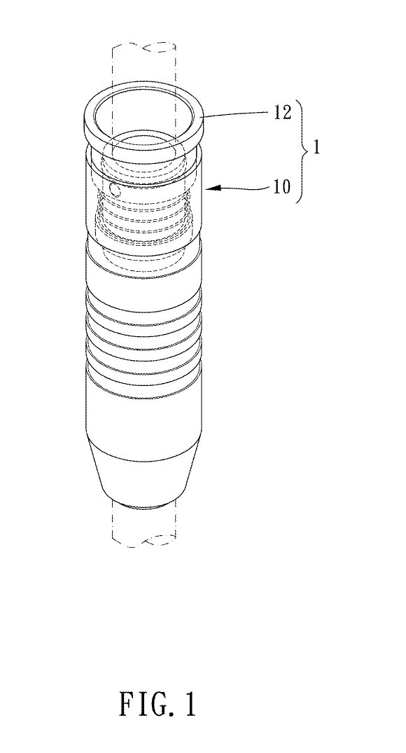

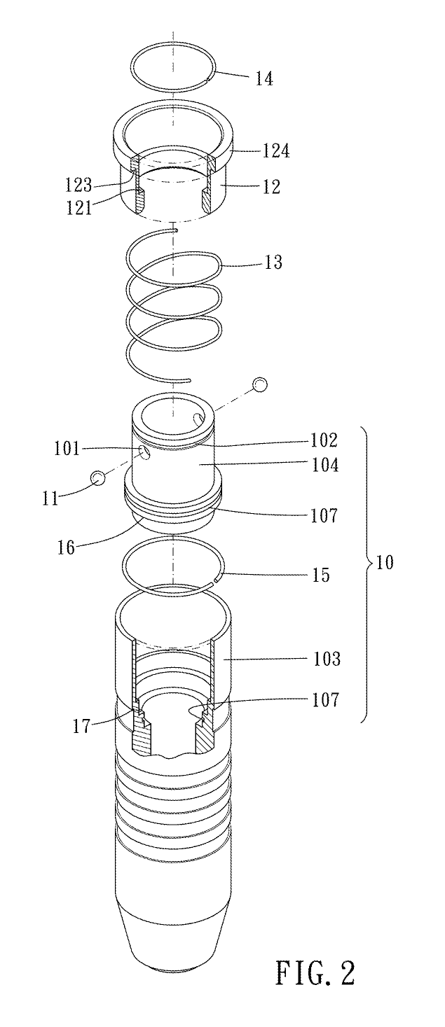

Please refer to FIGS. 1 to 4 for a first preferred embodiment of the present invention. A gripping sleeve 1 is provided for being restrictably and slidably sleeved on a body portion 21 of a main body 20 and rotatable relative to the body portion 21, the body portion 21 has at least one annular groove 22, and the gripping sleeve 1 includes a first sleeve 10, at least one restricting member 11, a second sleeve 12, an elastic member 13 and a restricting mechanism 14.

The first sleeve 10 is substantially tubular and has at least one through hole 10, more specifically, the first sleeve 10 has two through holes 101 which are opposite to each other, and the first sleeve 10 may have one, three, four or more through holes 101. With a plurality of through holes 101, the plurality of through holes 101 are preferably arranged equidistantly, but not limited thereto. The at least one restricting member 11 is received in the through hole 101, in this embodiment, a number of the at least one restricting member is two, the two restricting members are respectively received in one of the plurality of through holes, and preferably, each said restricting member 11 is a ball, for example, a bead, a steel ball or other similar structures. The second sleeve 12 is sleeved on the first sleeve 10 and is movable relative to the first sleeve 10, the restricting member 11 is abutted by the second sleeve 12, and a part of the restricting member 11 is controllably engaged within the annular groove 22 so as to make the gripping sleeve 1 engaged with the main body 20 so that the gripping sleeve 1 will not slide relative to the main body 20 or detach from the main body 20. The elastic member 13 is disposed around the first sleeve 10 and abuts against and between the first sleeve 10 and the second sleeve 12. The restricting mechanism 14 is arranged on at least one of the first sleeve 10 and the second sleeve 12 and located between the first sleeve 10 and an outer circumferential face of the second sleeve 12.

The restricting mechanism 14 is an annular clip, for example, a C-shaped clip, for being quickly assembled and disassembled, and the restricting mechanism 14 may be an annular clip which is continuously closed. In this embodiment, the restricting mechanism 14 is arranged on the first sleeve 10, preferably, the first sleeve 10 has an annular recess 102, and the restricting mechanism 14 is arranged in the annular recess 102 and radially protrudes beyond the annular recess 102 so that the restricting mechanism 14 is engaged with the first sleeve 10 and will not detach from the first sleeve 10 easily. An inner wall of the second sleeve 12 includes a blocking face 121 between the annular clip and the elastic member 13, and the blocking face 121 abuts against the annular clip to prevent the second sleeve 12 from falling off from the first sleeve 10 when being impacted by an exterior force (for example, the elastic member 13). More specifically, one end of the second sleeve 12 has a bottom face 122 which is opposite to the blocking face 121, and the elastic member 13 abuts against the bottom face 122.

The first sleeve 10 further includes an outer sleeve 103 and an inner sleeve 104, the second sleeve 12 is sleeved on the inner sleeve 104, a receiving groove 105 is formed between the inner sleeve 104 and the outer sleeve 103 and extends axially, the second sleeve 12 is sleeve on the inner sleeve 104 and movably arranged within the receiving groove 105, and the second sleeve 12 is stably movable relative to the receiving groove 105. In this embodiment, the elastic member 13 abuts against the second sleeve 12 and the inner sleeve 104, and the second sleeve 12 has a pressing portion 124 which partly protrudes axially beyond the receiving groove 105 so that it is convenient for a user to operate. A flange of the pressing portion 124 facing the outer sleeve 103 has an annular abutting face 123 which extends radially to restrict the second sleeve 12 to move relative to the first sleeve 10 within a released position.

The gripping sleeve 1 further includes a positioning mechanism 15, and the positioning mechanism 15 is arranged on at least one of the inner sleeve 104 and the outer sleeve 103 and located between the inner sleeve 104 and the outer circumferential face of the outer sleeve 103. In this embodiment, the positioning mechanism 15 is an annular member, for example, a C-shaped clip, for being quickly assembled and disassembled, and the positioning mechanism 15 may be an annular member which is continuously closed. In this embodiment, two opposite sides of the annular member are respectively partly engaged in the inner sleeve 104 and the outer circumferences of the outer sleeve 103. More specifically, at least one of circumferential faces of the inner sleeve 104 and the outer sleeve 103 has a ditch 107, the annular member is arranged in the ditch 107 and radially protrudes beyond the ditch 107, and one of the inner sleeve 104 and the outer sleeve 103 is abuttable against the annular member; in this embodiment, the inner sleeve 104 and the outer sleeve 103 respectively have the ditch 107 corresponding to each other, the two opposite sides of the annular member are respectively arranged in the ditch 107 so that the inner sleeve 104 and the outer sleeve 103 can be fixedly connected to each other prevent the inner sleeve 104 and the outer sleeve 103 from sliding relative to and detaching from each other. In this embodiment, the outer sleeve 103 is greater than the inner sleeve 104 in length, and the outer sleeve 103 may be for the user to grip thereon.

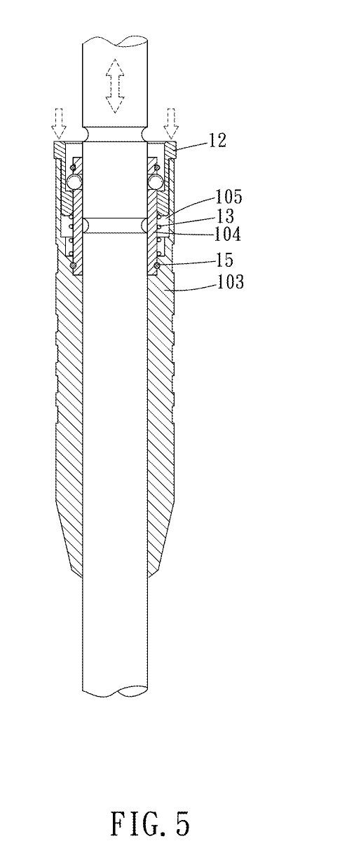

Please refer to FIG. 5 for a second preferred embodiment. The difference between the first and second preferred embodiments is that the elastic member 13 abuts against the second sleeve 12 and the outer sleeve 103.

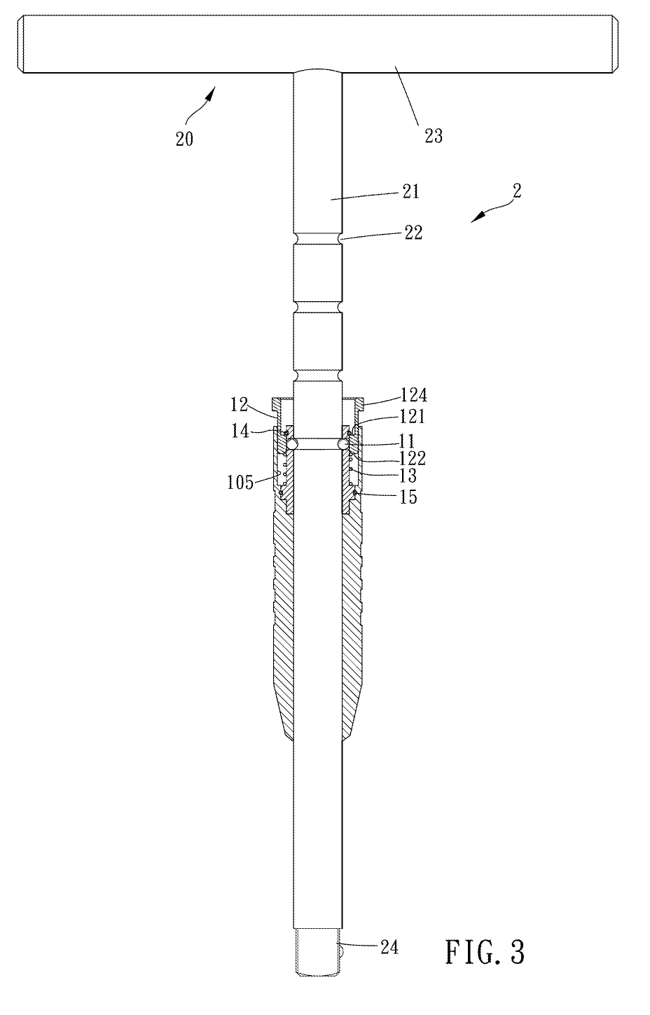

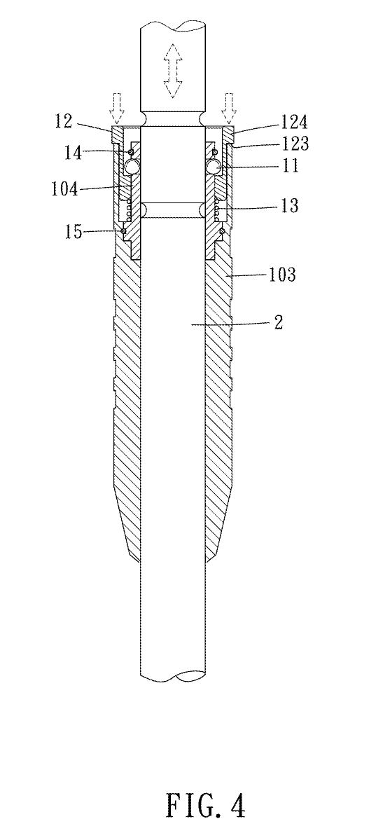

A hand tool 2 is further provided, including the above-mentioned gripping sleeve 1, and further including a main body 10. The main body 10 includes a body portion 21, the body portion 21 has at least one annular groove 22, the gripping sleeve 1 is restrictably and slidably sleeved on the body portion 21 of the main body 20 and rotatable relative to the body portion 21, the restricting member 11 is abutted by the second sleeve 12, and a part of the restricting member 11 is controllably engaged within the annular groove 22. When the second sleeve 12 is on a restricted position, as shown in FIG. 3, each said restricting member 11 is abutted by the second sleeve 12, and a part of the restricting member 11 is controllably engaged within the annular groove 22 and further makes the gripping sleeve 1 engaged with the body portion 21. In addition, the second sleeve 12 may also be moved relatively to the released portion, as shown in FIG. 4, to lift restriction so that the gripping portion 1 can slide relative to the body portion 21 of the main body 20, and the user can move the gripping sleeve 1 to change restriction positions of the gripping sleeve 1 and the body portion 21 of the main body 20 or to remove the gripping sleeve 1 from the body portion 21 of the main body 20. In this embodiment, the main body 20 further includes a driving portion 23 which is connected to one of two ends of the body portion 21 and a joint 24 which is connected to the other of the two ends of the body portion 21, the driving portion 23 may be a horizontal rod, for example, the driving portion 23 may be perpendicularly connected to the body portion 21 to be T-shaped, and the driving portion 23 may be a polygon or a ball; and the joint 24 may be sleeved on, for example, a socket.

While we have shown and described various embodiments in accordance with the present invention, it should be clear to those skilled in the art that further embodiments may be made without departing from the scope of the present invention.

What is claimed is:

1. A gripping sleeve, for being restrictably and slidably sleeved on a body portion of a main body and rotatable relative to the body portion, the body portion having at least one annular groove, the gripping sleeve including:
a first sleeve, being substantially tubular and having at least one through hole;
at least one restricting member, received in the through hole;
a second sleeve, sleeved on the first sleeve and being movable relative to the first sleeve, the restricting member being abutted by the second sleeve, a part of the restricting member being controllably engaged within the annular groove;
an elastic member, disposed around the first sleeve and abutting against and between the first sleeve and the second sleeve;
a restricting mechanism, arranged on at least one of the first sleeve and the second sleeve and located between the first sleeve and an outer circumferential face of the second sleeve;
wherein the first sleeve further includes an outer sleeve and an inner sleeve, a receiving groove is formed between the inner sleeve and the outer sleeve and extends axially, and the second sleeve is sleeve on the inner sleeve and movably arranged within the receiving groove.

2. The gripping sleeve of claim 1, wherein the elastic member abuts against and between the second sleeve and the outer sleeve.

3. The gripping sleeve of claim 1, further including a positioning mechanism, the positioning mechanism arranged on at least one of the inner sleeve and the outer sleeve and located between the inner sleeve and the outer circumferential face of the outer sleeve.

4. The gripping sleeve of claim 1, wherein the restricting mechanism is an annular clip, the restricting mechanism is arranged on the first sleeve, and an inner wall of the second sleeve includes a blocking face between the annular clip and the elastic member.

5. The gripping sleeve of claim 4, wherein one end of the second sleeve has a bottom face which is opposite to the blocking face, and the elastic member abuts against the bottom face.

6. The gripping sleeve of claim 4, wherein the first sleeve has an annular recess, and the restricting mechanism is arranged in the annular recess and radially protrudes beyond the annular recess.

7. The gripping sleeve of claim 6, wherein one end of the second sleeve has a bottom face which is opposite to the blocking face, and the elastic member abuts against the bottom face; the second sleeve has a pressing portion which partly protrudes axially beyond the receiving groove; a flange of the pressing portion facing the outer sleeve has an annular abutting face which extends radially; the elastic member abuts against the second sleeve and the outer sleeve or against the second sleeve and the inner sleeve; the outer sleeve is greater than the inner sleeve in length; the gripping sleeve further includes a positioning mechanism, the positioning mechanism is arranged on at least one of the inner sleeve and the outer sleeve and located between the inner sleeve and the outer circumferential face of the outer sleeve; the positioning mechanism is an annular member, at least one of circumferential faces of the inner sleeve and the outer sleeve has a ditch, the annular member is arranged in the ditch and radially protrudes beyond the ditch, and one of the inner sleeve and the outer sleeve is abuttable against the annular member; one of the inner sleeve and the outer sleeve radially protrudes to form a stepped protrusion, the other of the inner sleeve and the outer sleeve has a stepped groove which corresponds to be assemblable with the stepped protrusion, and the elastic member axially abuts against the stepped recess.

8. A hand tool, including the gripping sleeve and the main body of claim 1, wherein the main body further includes a driving portion which is connected to one of two ends of the body portion and a joint which is connected to the other of the two ends of the body portion.
